(19) United States
(12) Patent Application Publication
(10) Pub. No.: US 2009/0183991 A1
(43) Pub. Date: Jul. 23, 2009

(54) CORROSION DETECTION METHOD AND MONITORING PATTERN USED THEREIN

(75) Inventor: Yukio Yamamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/338,040

(22) Filed: Dec. 18, 2008

(30) Foreign Application Priority Data
Jan. 22, 2008 (JP) 2008-011112

(51) Int. Cl. C25D 5/00; B32B 3/10

(52) U.S. Cl. 205/81; 428/601

(57) ABSTRACT

A corrosion detection method detects galvanic corrosion occurring in a heterogeneous metal layer using a forming step and an observing step. The forming step is the step of forming the heterogeneous metal layer and a monitoring pattern by electrolytic plating a plurality of types of metal layers on a substrate. The observing step is the step of observing a surface of the monitoring pattern from above. The monitoring pattern has an identical structure of the heterogeneous metal layer. The monitoring pattern is in an area different from an area in which the heterogeneous layer is formed on the substrate.

### CROSS-REFERENCE TO RELATED APPLICATION

This application is based upon and claims the benefit of priority of prior Japanese Patent Application No. 2008-11112, filed on Jan. 22, 2008, the entire contents of which are incorporated herein by reference.

### BACKGROUND

1. Field

An aspect of the invention is related to a corrosion detection method for detecting galvanic corrosion occurring in a heterogeneous metal layer formed by electrolytic plating multiple types of metal layers, and a monitoring pattern used in the corrosion detection method.

2. Description of the Related Art

A main magnetic pole embedded in a magnetic head used for perpendicular magnetic recording is made by electrolytically plating a metal made from high Bs material on a soft magnetic metal layer to increase a recording property. The main magnetic pole is made of multiple types of metal layers. The heterogeneous metal layer forming the main magnetic pole includes layers formed by sputtering and electrolytic plating. The heterogeneous metal layer is an ultra thin layer, in a thickness of 2 to 3 μm. Because of its thickness, the heterogeneous layer may become corroded by a residue of solution for plating that remains after the plating, i.e., galvanic corrosion may occur by the residue of the solution.

FIG. 3 is a photograph showing a case in which galvanic corrosion occurs on the main magnetic pole. FIG. 3 shows a sectional view of the narrow portion of a recording surface (i.e., an air bearing surface) of the main magnetic pole along a section line shown in FIG. 4. FIG. 5 is a photograph showing a sectional view of a main magnetic pole in which galvanic corrosion does not occur. The main magnetic pole shown in FIGS. 3 and 5 is made of a FeCo layer that is formed by sputtering as a seed layer for the electrolytic plating, a CoNiFe layer and a NiFe layer plated electrolytically thereon. In the example shown in FIG. 3, galvanic corrosion occurs in the CoNiFe layer.

A resist pattern is formed on the seed layer. The resist pattern is used as a mask layer for electrolytic plating. Therefore, the main magnetic pole is formed by pattern plating in a shape shown in FIG. 4. After the pattern plating, the resist pattern is removed chemically. Then the main magnetic pole is shaped by a method such as ion milling as necessary.

A width of the narrow portion of the main magnetic pole is about 0.1 μm. It is very narrow. Even if galvanic corrosion occurs in the inner layer of the narrow portion of the main magnetic pole, the main magnetic pole is connected with the wider portion and the main magnetic pole does not fall down. Thus, galvanic corrosion occurring in the inner layer of the main magnetic pole is difficult to detect by outside observation.

To check whether galvanic corrosion occurs, one can form the heterogeneous metal layer by plating, section the heterogeneous metal layer and check the section visually.

However, sectioning the heterogeneous layer takes much time. Since the sectioning takes much time, the time for checking the main magnetic poles is limited, which leads to a delay in finding the corrosion.

As described above, there has been no effective method to detect galvanic corrosion occurring in the heterogeneous layer formed by the multiple types of metal layers.

### SUMMARY

Accordingly, it is an object of the embodiments to provide a method for detecting galvanic corrosion within a short period of time with a simple technique, and a monitoring pattern used in the method.

According to an aspect of the invention, a corrosion detection method which detects galvanic corrosion occurring in a heterogeneous metal layer includes a forming step and a observing step. The forming step is the step of forming the heterogeneous metal layer and a monitoring pattern by electrolytic plating a plurality of types of metal layers on a substrate. The observing step is the step of observing a surface of the monitoring pattern from above. The monitoring pattern has an identical structure of the heterogeneous metal layer. The monitoring pattern is in an area different from an area in which the heterogeneous layer is formed on the substrate.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The embodiments of the present invention will be explained with reference to the accompanying drawings.

FIG. 1 is an example of a monitoring pattern;

FIG. 2 is the monitoring pattern from which plating films C and B have been removed;

FIG. 3 is a photograph showing a sectional view of the main magnetic pole in which galvanic corrosion occurs;

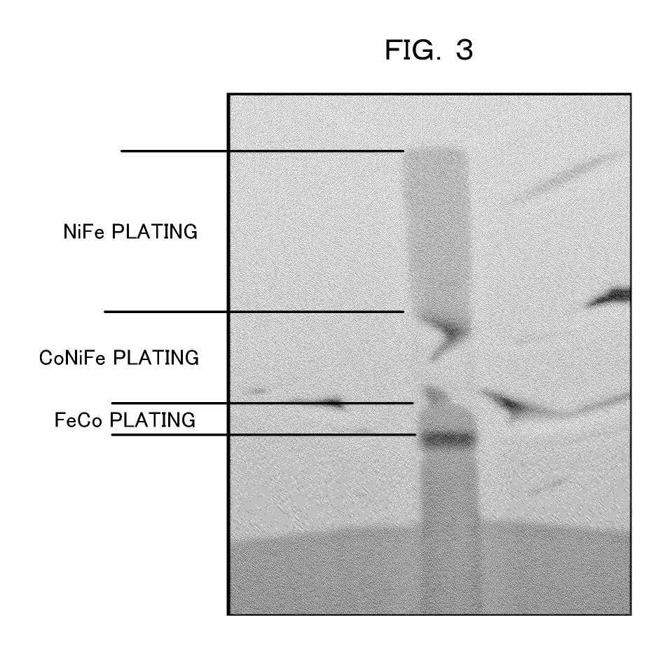

FIG. 4 is the outer shape of the main magnetic pole; and

FIG. 5 is a photograph showing the sectional view of the main magnetic pole in which galvanic corrosion does not occur.

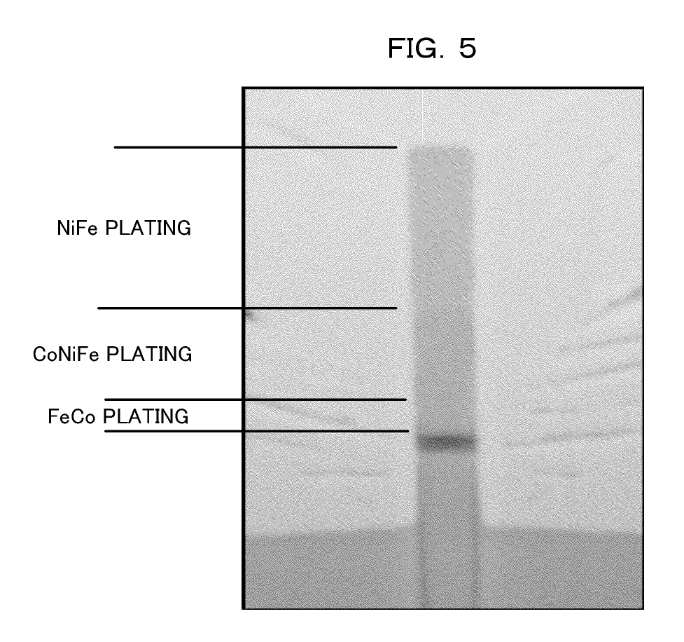

### DETAILED DESCRIPTION OF THE PREFERRED EMBODIMENTS

Embodiments of the present invention will be described in detail below with reference to the accompanying drawings.

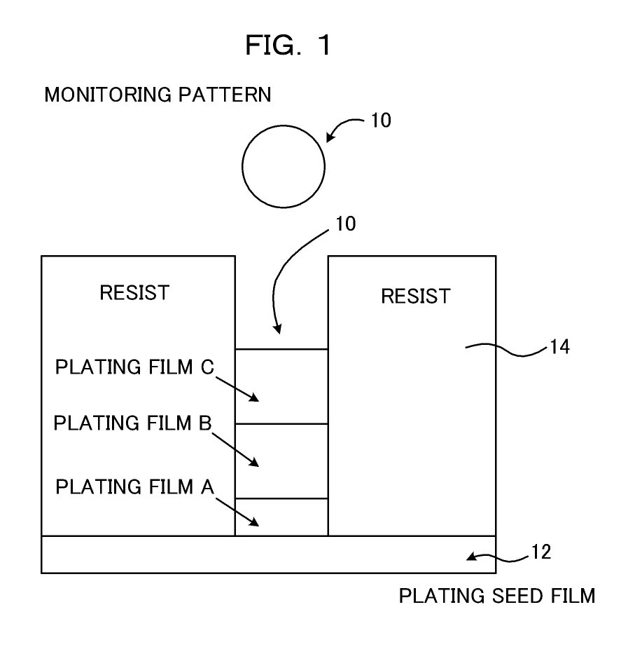

FIG. 1 is an example of a monitoring pattern. Monitoring pattern 10 is made of, for example, a heterogeneous metal layer formed by electrolytically plating the multiple types of metal layers on a substrate. Monitoring pattern 10 is formed with the same structure as the heterogeneous metal layer forming the main magnetic pole, on the same substrate in parallel with forming the main magnetic pole of the write head for perpendicular magnetic recording.

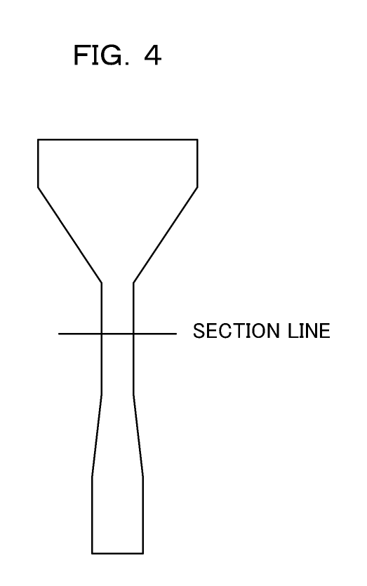

In the example shown in FIG. 1, a seed layer 12 is formed by sputtering on the substrate (not shown in FIG. 1.) Then resist is coated on seed layer 12. Resist pattern 14 for forming the main magnetic pole (made of the heterogeneous metal layer) and monitoring pattern 10 shown in FIG. 4 are formed by exposing and developing the resist with photolithography.

Then plating films are done by electrolytic plating on seed layer 12 in the order of A, B and C. Seed layer 12 serves as a seed layer for plating, and resist pattern 14 serves as a mask for plating. With the plating, the main magnetic pole (made of the heterogeneous metal layer) and monitoring pattern 10 are formed with the same structure at the same time. Therefore, the main magnetic pole (made of the heterogeneous layer) and monitor pattern 10 are formed in parallel. Monitoring pattern 10 is formed on a portion of the substrate that is not used for the magnetic head.

The heterogeneous metal layer according to the embodiment of the present invention is made of four types of metal layers including seed layer 12. However, the heterogeneous metal layer may include two or more different types of metal layers.

The main magnetic pole (made of the heterogeneous metal layer) of the write head for perpendicular magnetic recording and monitoring pattern 10 may be made from a metallic material such as FeCo, FeCo_{α} (α=Pd, Pt, Rh, Mo and Zr), CoNiFe, NiFe and NiFe_{α} (α=Pd, Pt, Rh, Mo and Zr) selectively.

When heterogeneous metal layers are not for forming the main magnetic pole, heterogeneous metal layers not described in this application may be used.

After forming the main magnetic pole (made of the heterogeneous metal layer) and monitoring pattern 10, resist pattern 14 is dissolved and removed with resist remover to expose the main magnetic pole and monitoring pattern 10.

When the heterogeneous metal layer including seed layer 12 is the main magnetic pole of the write head for perpendicular magnetic recording, the main magnetic pole is shaped by ion milling.

A dimension of monitoring pattern 10 is not considered to be limited. However, monitoring pattern 10 may be formed in a dimension such that the monitoring pattern 10 is corroded and vanished with galvanic corrosion. In terms of the monitoring pattern of the main magnetic pole of the magnetic head, the dimension (diameter) of the monitoring pattern is equal to or less than a width of the main magnetic pole (more specifically, a width of a recording surface of the main magnetic pole.)

The shape of monitoring pattern 10 is not limited. However, a circular shape may be optimal on an assumption that the monitoring pattern is corroded evenly from its rim.

Monitoring pattern 10 is formed as described below. Whether galvanic corrosion occurs is judged as follows, because galvanic corrosion will occur, in the main magnetic pole (made of the heterogeneous metal layer) and monitoring pattern 10. For monitoring pattern 10 formed in a small dimension, a layer in which galvanic corrosion occurs and the layers formed on the corroded layer are removed together with the resist in a removal process of resist pattern 14, and the corroded portion is exposed. In some cases, monitoring pattern 10 is deformed by the corroded layers and the layers formed thereon that are not removed completely.

If galvanic corrosion occurs, the surface of the exposed layer is uneven. The exposed layer of monitoring pattern 10 is observed with a microscope to check whether the surface of the layer is even or uneven. If the surface of the exposed layer is uneven, galvanic corrosion occurs. The surface may be checked visually or automatically with a measuring equipment (not shown in the accompanying drawings.) The measurement equipment compares, for example, an intensity of reflected light of a smooth surface preconfigured in the measurement equipment with an intensity of reflected light of the measured layer. The measurement equipment may be configured to judge that galvanic corrosion occurs where the intensity of the reflected light of the measured layer is lower than a threshold or the shape of monitoring pattern 10 is deformed.

Multiple main magnetic poles (i.e., the magnetic write heads) are formed on a wafer. Monitor pattern 10 is formed in each area on the wafer. If galvanic corrosion is detected in monitoring pattern 10 formed in one of the areas, the main magnetic pole formed on the area is separated and discarded as a corrosion defect.

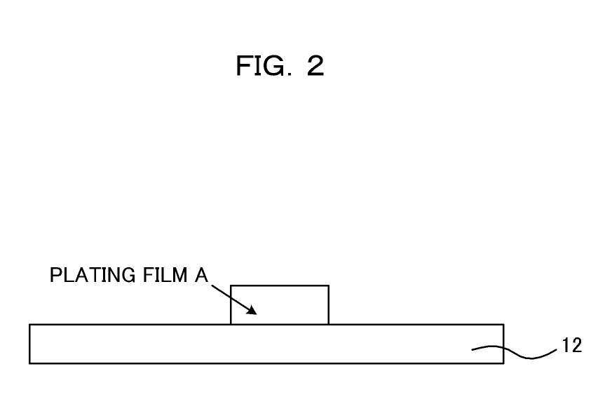

In the embodiment described above, the reflected light of the surface of the corroded layer is measured to detect galvanic corrosion. Alternatively, galvanic corrosion may be detected by measuring a thickness of monitoring pattern 10. If galvanic corrosion occurs, the corroded layer and the layers formed thereon are removed together with the resist as previously described. For example, plating films C and B are removed and only plating film A remains as shown in FIG. 2. Therefore, the thickness of monitoring pattern 10 is decreased. Thus, galvanic corrosion is detected by measuring the thickness of the monitor pattern 10. Likewise, when the monitoring pattern 10 is deformed, galvanic corrosion is detected by measuring the thickness, because the thickness of monitoring pattern 10 is different from a normal thickness.

As already described, galvanic corrosion occurring in the narrow portion of the main magnetic pole is not detected by outside observation. Because the main magnetic pole is connected with its wide portion. However, monitoring pattern 10 in a small dimension is formed together with the main magnetic pole in this embodiment. Therefore, galvanic corrosion occurs in monitoring pattern 10 when the main magnetic pole is corroded in a manufacturing process because monitoring pattern 10 has the same structure of the main magnetic pole. Moreover, a corrosion defect occurring in monitoring pattern 10 is observed from outside because monitoring pattern 10 is formed very small. Thus, the corrosion defect in the main magnetic pole is detected easily. Since monitoring patterns 10 are formed in parallel with forming the main magnetic poles. Thus, a conventional time-consuming post-process to section the main magnetic pole for observation is eliminated.

Accordingly, the corrosion detection method and the monitoring pattern used in the corrosion detection method may judge whether galvanic corrosion occurs in the main magnetic pole by observing the surface of the exposed layer of the monitoring pattern with a microscope, or measuring the thickness of the monitoring pattern, instead of observing the section of the main magnetic pole. Moreover, since the monitoring pattern is formed in each area on the substrate, an area in which galvanic corrosion occurs may be detected easily. Therefore, whether galvanic corrosion occurs may be detected in a forming process of the heterogeneous layer, which avoids the issue that galvanic corrosion may be detected in the later process.

The order in which the embodiments have been described does not indicate superiority and inferiority of one embodiment over another. Although the embodiments of the present inventions have been described in detail, it should be understood that the various changes, substitutions, and alterations could be made hereto without departing from the spirit and scope of the invention.

What is claimed is:

1. A corrosion detection method detecting galvanic corrosion occurring in a heterogeneous metal layer, comprising the steps of:
a forming step of forming the heterogeneous metal layer and a monitoring pattern by electrolytic plating a plurality of types of metal layers on a substrate; and
an observing step of observing a surface of the monitoring pattern from above,
wherein the monitoring pattern has an identical structure of the heterogeneous metal layer, and
the monitoring pattern is in an area different from an area in which the heterogeneous layer is formed on the substrate.

2. The corrosion detection method according to claim 1,
wherein the forming step comprises the steps of:
forming the heterogeneous metal layer by electrolytic plating with a resist pattern as a mask; and
removing the resist pattern.

3. The corrosion detection method according to claim 2,
wherein the observing step is the step of observing a surface status and a thickness of the monitoring pattern.

4. The corrosion detection method according to claim 1,
wherein the observing step is the step of observing a surface status and a thickness of the monitoring pattern.

5. A monitoring pattern, comprising:
a plurality types of metal layers on the substrate,
wherein the monitoring pattern has an identical structure of an heterogeneous metal layer, and
the monitoring pattern is in an area different from an area in which the heterogeneous layer is formed on the substrate.

6. The monitoring pattern according to claim 5,
wherein the monitoring pattern is formed in a circular shape in the heterogeneous metal layer.

7. The monitoring pattern according to claim 5,
wherein a main magnetic pole of a magnetic head is made in the heterogeneous metal layer formed by electrolytically plating the plurality types of metal layers, and
a radius of the monitoring pattern is equal or less than a width of the main magnetic pole.

8. The monitoring pattern according to claim 6,
wherein a main magnetic pole of a magnetic head is made in the heterogeneous metal layer formed by electrolytically plating the plurality types of metal layers, and
a radius of the monitoring pattern is equal or less than a width of the main magnetic pole.
